(19) United States
(12) Patent Application Publication
(10) Pub. No.: US 2002/0050090 A1
(43) Pub. Date: May 2, 2002

(54) Rising crank bait lure

(76) Inventor: David G. Lloyd, Brookfield, WI (US)

Correspondence Address: Donald J. Ersler, 725 Garvens Avenue, Brookfield, WI, 53005, US

(21) Appl. No.: 10/001,609

(22) Filed: Oct. 31, 2001

Related U.S. Application Data
(60) Provisional application No. 60/245,837, filed on Nov. 2, 2000.

(51) Int. Cl. A01K 85/00

(52) U.S. Cl. 43/42.22

(57) ABSTRACT

A rising crank bait lure includes a body, a forward sloping lip, at least one hook, and a line loop. The body preferably has the shape of a minnow, but could be shaped as any other fish. The body may be either a single piece or a multiple piece design. The forward sloping lip may be attached to a front of the body, to a top of the body at substantially a front thereof, or to a bottom of the body at substantially a front thereof. The extended end of the lip is preferably rounded to decrease drag. The line loop extends from a front of the body for attachment of a fishing line. At least one hook is attached to a bottom of the body. The body is preferably painted to resemble a fish.

### CROSS-REFERENCES TO RELATED APPLICATIONS

This is a utility application taking priority from provisional patent application, serial No. 60/245,837 filed on Nov. 2, 2000.

### BACKGROUND OF THE INVENTION

1. Field of the Invention

The present invention relates generally to bait lures and more specifically to a rising crank bait lure which rises when it is pulled through the water.

2. Discussion of the Prior Art

Currently, crank bait lures are designed to sink when pulled through the water. The “sinking” characteristic often results in the bait lure being caught on a bottom of a lake or other body of water when the crank bait lure is trolled along the bottom.

Accordingly, there is a clearly felt need in the art for a rising crank bait lure which rises when pulled through the water and which resists being caught on the bottom of a body of water when trolled.

### SUMMARY OF THE INVENTION

The present invention provides a rising bait lure which rises when pulled through water. The rising crank bait lure includes a body, a forward sloping lip, at least one hook, and a line loop. The body preferably has the shape of a minnow, but could be shaped as any other fish. The body may be either a single piece or multiple piece design. The forward sloping lip may be attached to a front of the body, to a top of the body at substantially a front thereof, or to a bottom of the body at substantially a front thereof. The extended end of the lip is preferably rounded to decrease drag. The line loop extends from a front of the body for attachment of a fishing line. Preferably, one treble hook is pivotally attached to a bottom of the body in substantially a middle and a second treble hook is attached to a rear of the body. The body is preferably painted to resemble a fish.

Accordingly, it is an object of the present invention to provide a rising crank bait lure which rises when pulled through the water.

Finally, it is another object of the present invention to provide a rising crank bait lure which may be trolled along a bottom of a body of water without running the risk of snagging the bottom.

These and additional objects, advantages, features and benefits of the present invention will become apparent from the following specification.

### BRIEF DESCRIPTION OF THE DRAWINGS

FIG. 1a is an enlarged front perspective view of a forward sloping lip in accordance with the present invention.

FIG. 1b is an enlarged rear perspective view of a forward sloping lip in accordance with the present invention.

FIG. 2 is a side view of a first embodiment of a rising crank bait lure in accordance with the present invention.

FIG. 3 is a side view of a second embodiment of a rising crank bait lure in accordance with the present invention.

FIG. 4 is a side view of a third embodiment of a rising crank bait lure in accordance with the present invention.

FIG. 5 is a top view of a first embodiment of a rising crank bait lure in accordance with the present invention.

FIG. 6 is a top view of a second embodiment of a rising crank bait lure in accordance with the present invention.

FIG. 7 is a top view of a third embodiment of a rising crank bait lure in accordance with the present invention.

FIG. 8 is an enlarged front view of a first embodiment of a rising crank bait lure in accordance with the present invention.

FIG. 9 is an enlarged front view of a second embodiment of a rising crank bait lure in accordance with the present invention.

FIG. 10 is an enlarged front view of a third embodiment of a rising crank bait lure in accordance with the present invention.

FIG. 11 is side view of a rising crank bait lure attached to a fishing line with a weight attached thereto in accordance with the present invention.

FIG. 12 is side view of a rising crank bait lure attached to 3-way swivel in accordance with the present invention.

### DETAILED DESCRIPTION OF THE PREFERRED EMBODIMENTS

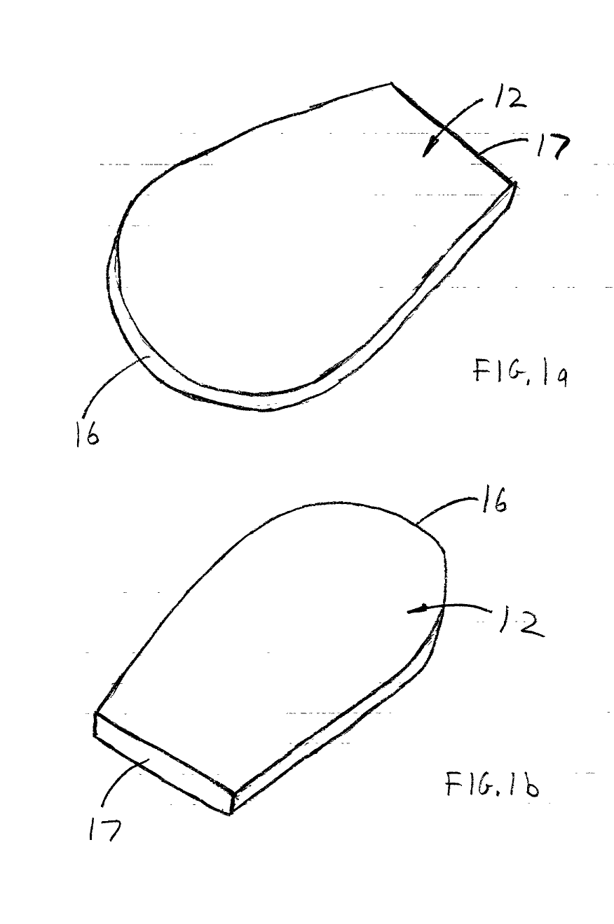

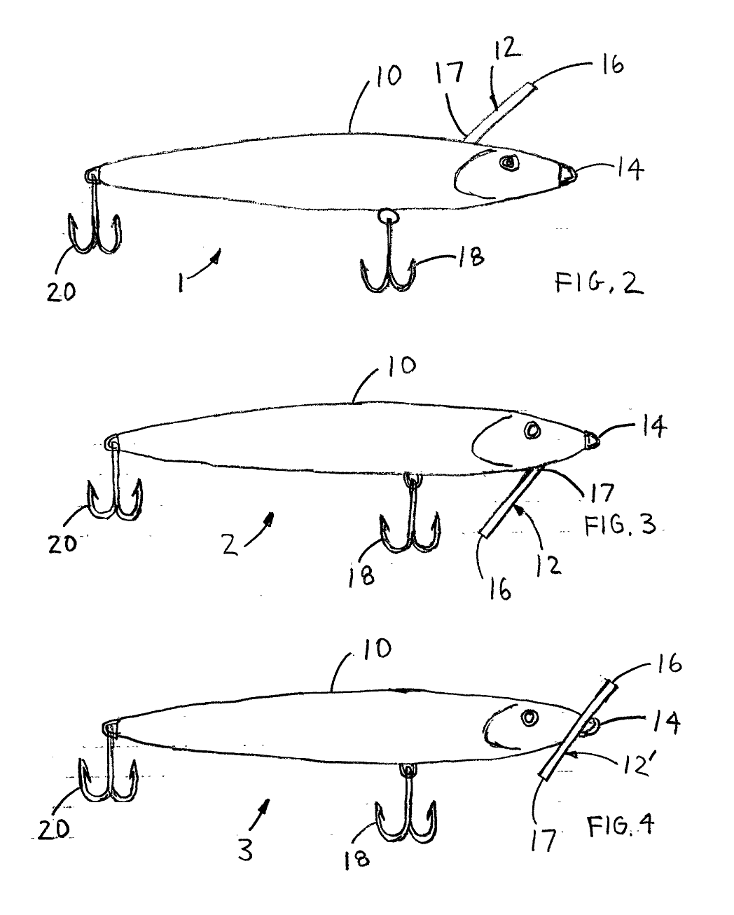

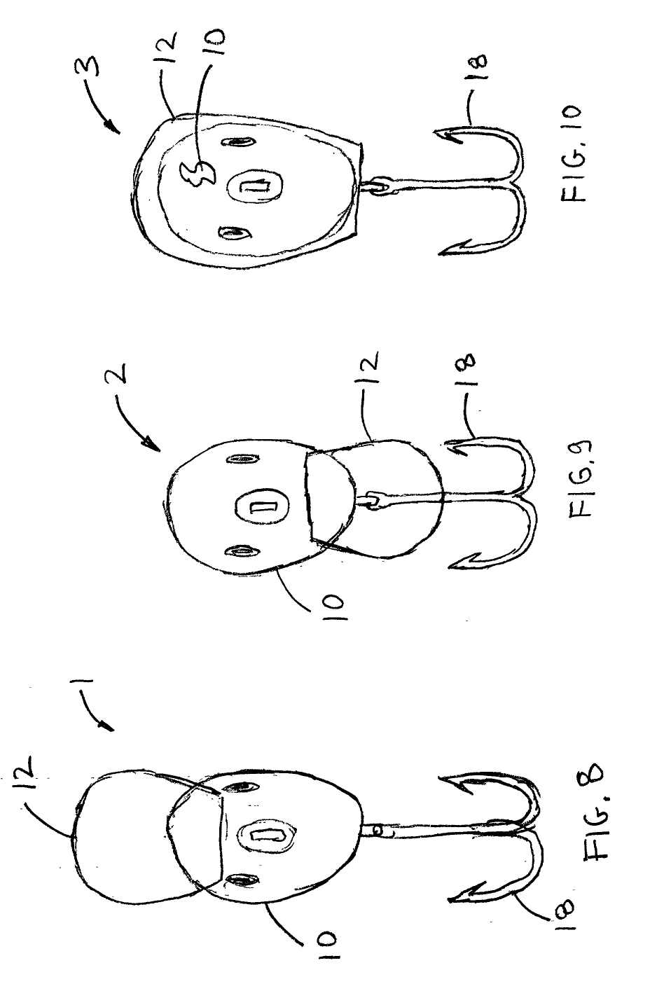

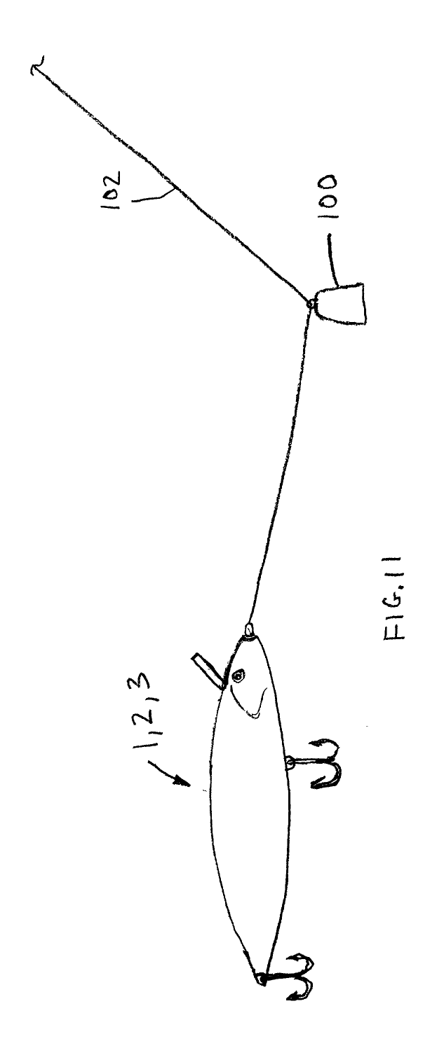

With reference now to the drawings, and particularly to FIGS. 1a and 1b, there is shown a perspective view of a forward sloping lip 12 of a rising crank bait lure 1. With reference to FIGS. 2, 5, and 8, the rising crank bait lure 1 includes a body 10, a forward sloping lip 12, at least one hook, and a line loop 14. The body 10 preferably has the shape of a minnow, but could be shaped as any other fish. The body 10 may be either a single piece or a multiple piece design. The body 10 may be fabricated from wood, plastic or any other suitable material. The body 10 is preferably painted to resemble a fish.

The forward sloping lip 12 derives its name from the fact that a forward slash mark (/) used as a symbol in computer data entry has the same orientation. Some prior art crank baits have a back sloping lip corresponding to a back slash mark (\). The back sloping lip causes the crank bait to sink or dive. The forward sloping lip 12 extends from a top of the body at substantially a front thereof. The angle of the lip 12 relative to the horizontal axis preferably ranges from 25 to 65 degrees. The extended end 16 of the lip 12 is preferably rounded to decrease drag. The width of the extended end 16 is preferably wider than an attachment end 17 to also decrease drag. The extended end 16 is preferably at least as wide as the as the width of the body 10. The greater the width of the lip 12 the greater the rising action when pulled through the water.

The lip 12 may be attached to the body 10 by forming a slot in the body 10 which is sized to receive the thickness of the lip 12 and applying adhesive to the union of the body 10 and the lip 12. Other assembly methods may also be used. The lip 12 is preferably fabricated from clear or translucent plastic. The lip 12 and the body 10 could also be molded as a single piece. The line loop 14 extends from a front of the body for attachment of a fishing line. Preferably, a first treble hook 18 is pivotally attached to a bottom of the body 10 at substantially a middle and a second treble hook 20 is attached to a rear of the body 10.

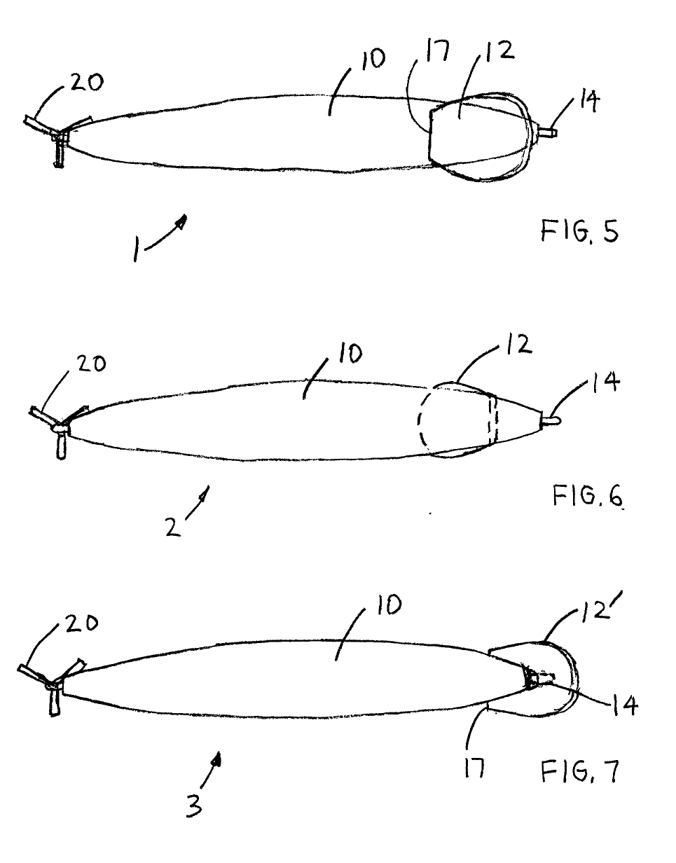

With reference to FIGS. 3, 6, and 9, the rising crank bait lure 2 includes the body 10, the forward sloping lip 12, the at least one hook, and the line loop 14. The lip 12 is attached to a bottom of the body 10 at substantially a front thereof. The angle of the lip 12 relative to the horizontal axis preferably ranges from 25 to 65 degrees. The extended end 16 of the lip 12 is preferably rounded to decrease drag. The lip 12 may be attached to body 10 by forming a slot in the body 10 which is sized to receive the thickness of the lip 12 and applying adhesive to the union of the body 10 and the lip 12. Other assembly methods may also be used. The lip 12 and the body 10 could also be molded as a single piece. The lip 12 is preferably fabricated from clear or translucent plastic.

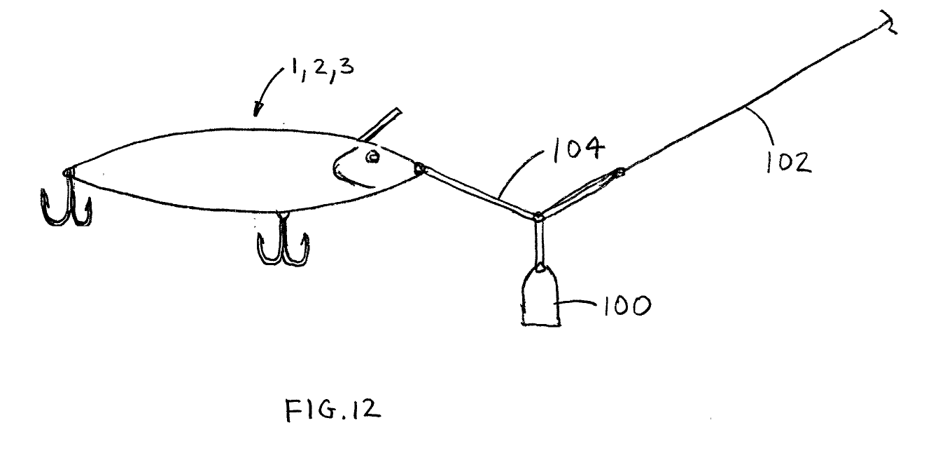

With reference to FIGS. 4, 7, and 10, the rising crank bait lure 3 includes the body 10, a forward sloping lip 12′, the at least one hook, and the line loop 14. The lip 12′ extends from a bottom of the body at substantially a front thereof. The angle of the lip 12′ relative to the horizontal axis preferably ranges from 25 to 65 degrees. The extended end 16 of the lip 12′ is preferably rounded to decrease drag. A back of the lip 12′ may be attached to body 10 with a suitable adhesive. Other assembly methods may also be used. The lip 12′ and the body 10 could also be molded as a single piece. The line loop 14 is attached to a front of the body 10 through a clearance hole formed in the lip 12′. The lip 12′ is preferably fabricated from clear plastic.

With reference to FIGS. 11 and 12, it is preferred that the rising crank bait lures 1, 2 or 3 include a weight 100 for fishing off the bottom. The weight 100 may be attached to a fishing line 102 in front the rising crank bait lure 1, 2 or 3 as shown in FIG. 11. The weight may also be suspended from a 3-way swivel 104 as shown in FIG. 12. The other ends of the 3-way swivel 104 are attached to the rising crank bait lure 1, 2 or 3 and the fishing line 102. In either case, the weight keeps the rising crank bait lure 1, 2 or 3 near the bottom while being trolled. Other methods of weighing the rising crank bait lure 1, 2 or 3 may also be used. However, it is not required that the rising bait lure 1, 2 or 3 be used with a weight.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A rising crank bait lure comprising:
a body being shaped like a fish, said body having a front and a rear;
a forward sloping lip extending from a top of said body at substantially said front thereof;
at least one hook extending from a bottom of said body; and
a line loop extending from said front of said body for the attachment of a fishing line.

2. The rising crank bait lure of claim 1 wherein:
said forward sloping lip having a rounded extended end.

3. The rising crank bait lure of claim 2 wherein:
a width of said rounded end being greater than a width of an attachment end.

4. The rising crank bait lure of claim 1 wherein:
said forward sloping lip being fabricated from one of a clear and translucent material.

5. The rising crank bait lure of claim 1, further comprising:
a weight being attached to a fishing line in front of said rising crank bait.

6. The rising crank bait lure of claim 1, further comprising:
a 3-way swivel being attached to said rising crank bait, a weight, and a fishing line.

7. A rising crank bait lure comprising:
a body being shaped like a fish, said body having a front and a rear;
a forward sloping lip being attached to said front of said body;
at least one hook extending from a bottom of said body; and
a line loop extending from a front of said body for the attachment of a fishing line.

8. The rising crank bait lure of claim 7 wherein:
said forward sloping lip having a rounded extended end.

9. The rising crank bait lure of claim 7 wherein:
a width of said rounded end being greater than a width of an attachment end.

10. The rising crank bait lure of claim 7 wherein:
said forward sloping lip being fabricated from one of a clear and translucent material.

11. The rising crank bait lure of claim 7, further comprising:
a weight being attached to a fishing line in front of said rising crank bait.

12. The rising crank bait lure of claim 7, further comprising:
a 3-way swivel being attached to said rising crank bait, a weight, and a fishing line.

13. A rising crank bait lure comprising:
a body being shaped like a fish, said body having a front and a rear;
a forward sloping lip extending from a bottom of said body at substantially a front thereof;
at least one hook extending from a bottom of said body; and
a line loop extending from a front of said body for the attachment of a fishing line.

14. The rising crank bait lure of claim 13 wherein:
said forward sloping lip having a rounded extended end.

15. The rising crank bait lure of claim 14 wherein:
a width of said rounded end being greater than a width of an attachment end.

16. The rising crank bait lure of claim 13 wherein:
said forward sloping lip being fabricated from one of a clear and translucent material.

17. The rising crank bait lure of claim 13, further comprising:
a weight being attached to a fishing line in front of said rising crank bait.

18. The rising crank bait lure of claim 13, further comprising:
a 3-way swivel being attached to said rising crank bait, a weight, and a fishing line.
